(19) United States
(12) Patent Application Publication
(10) Pub. No.: US 2008/0086594 A1
(43) Pub. Date: Apr. 10, 2008

(54) Uncacheable load merging

(75) Inventors: Po-Yung Chang, Saratoga, CA (US); Ramesh Gunna, San Jose, CA (US); Tse-Yu Yeh, Cupertino, CA (US); James B. Keller, Redwood City, CA (US)

Correspondence Address: MEYERTONS, HOOD, KIVLIN, KOWERT & GOETZEL, P.C., P.O. BOX 398, AUSTIN, TX, 78767-0398, US

(73) Assignee: P.A. Semi, Inc., Santa Clara, CA (US)

(21) Appl. No.: 11/545,825

(22) Filed: Oct. 10, 2006

(51) Int. Cl. G06F 12/00

(52) U.S. Cl. 711/118

(57) ABSTRACT

In one embodiment, a processor comprises a buffer and a control unit coupled to the buffer. The buffer is configured to store requests to be transmitted on an interconnect on which the processor is configured to communicate. The buffer is coupled to receive a first uncacheable load request having a first address. The control unit is configured to merge the first uncacheable load request with a second uncacheable load request that is stored in the buffer responsive to a second address of the second load request matching the first address within a granularity. A single transaction on the interconnect is used for both the first and second uncacheable load requests, if merged. Separate transactions on the interconnect are used for each of the first and second uncacheable load requests if not merged.

### BACKGROUND

1. Field of the Invention

This invention is related to the field of processors and, more particularly, to the handling of uncacheable load memory operations in processors.

2. Description of the Related Art

Processors are configured to execute instructions defined in an instruction set architecture implemented by the processor. Typically, the processors are designed to communicate with other components in a system via an interconnect. The other components may be directly connected to the interconnect, or may be indirectly connected through other components. For example, many systems include an input/output (I/O) bridge connecting I/O components to the interface.

Processors typically implement one or more caches, and most fetch and load/store operations in the processors are cacheable. For such operations, the processors typically communicate cache-block-sized data transfers on the interconnect. For example, the processors may read cache blocks into the cache in response to fetch and/or load/store operations that miss in the cache, and may write back modified cache blocks to memory. The cache blocks may be accessed numerous times while in cache, which may reduce the number of transactions performed by the processor on the interconnect.

Instruction set architectures also often define uncacheable (or noncacheable) load/store memory operations in various forms. Uncacheable operations may be used to communicate with system components that do not cache and that are not capable of communicating in cache-sized blocks, for example. Uncacheable operations may also be used to access memory that is not desirable to cache. For example, graphics data stored in memory (to be displayed on a computer monitor screen) is typically read by a graphics device that interfaces with the monitor, and may be read repeatedly for display. To avoid interfering with (and possibly delaying) the reading of the data by the graphics device, such data may be uncacheable. Numerous other uses for uncacheable memory operations are possible.

Uncacheable load memory operations (or more briefly, “uncacheable loads”) may present performance issues in a system. Typically, each uncacheable load is performed as a separate communication (or transaction) on the interconnect on which the processor communicates. These transactions consume bandwidth on the interconnect. If bandwidth is a performance-limiter in the system, the consumption of bandwidth may reduce the overall performance of the system. Also, uncacheable transactions may often occur in bursts, close to each other in time. Even if overall bandwidth is sufficient, performance may suffer during times that the rate of uncacheable transactions is high. Furthermore, to the extent that the transactions cause significant power consumption in a system, these transactions may increase the average power consumption.

### SUMMARY

In one embodiment, a processor comprises a buffer and a control unit coupled to the buffer. The buffer is configured to store requests to be transmitted on an interconnect on which the processor is configured to communicate. The buffer is coupled to receive a first uncacheable load request having a first address. The control unit is configured to merge the first uncacheable load request with a second uncacheable load request that is stored in the buffer responsive to a second address of the second load request matching the first address within a granularity. A single transaction on the interconnect is used for both the first and second uncacheable load requests, if merged. Separate transactions on the interconnect are used for each of the first and second uncacheable load requests if not merged.

In another embodiment, a method comprises receiving a first uncacheable load request having a first address; merging the first uncacheable load request with a second uncacheable load request that is stored in a buffer awaiting transmission on an interconnect, the merging responsive to a second address of the second load request matching the first address within a granularity; and performing a single transaction on the interconnect for both the first and second uncacheable load requests, if merged.

### BRIEF DESCRIPTION OF THE DRAWINGS

The following detailed description makes reference to the accompanying drawings, which are now briefly described.

FIG. 1 is a block diagram of one embodiment of a system including a processor.

FIG. 2 is a block diagram of a portion of one embodiment of the processor shown in FIG. 1 in greater detail.

FIG. 3 is a flowchart illustrating operation of one embodiment of components shown in FIG. 2 in response to an uncacheable load request.

FIG. 4 is a flowchart illustrating operation of one embodiment of components shown in FIG. 2 in response to data being returned from a transaction for one or more uncacheable load request(s).

FIG. 5 is a timing diagram illustrating one embodiment of delayed transmission of byte enables on the interconnect.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

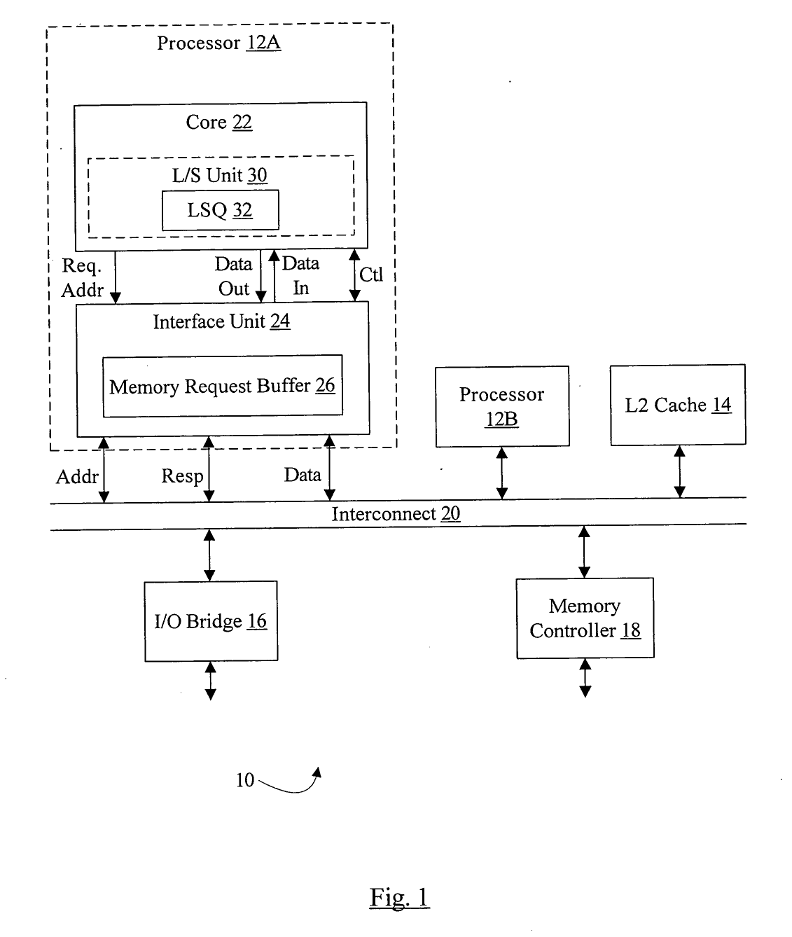

Turning now to FIG. 1, a block diagram of one embodiment of a system 10 is shown. In the illustrated embodiment, the system 10 includes processors 12A-12B, a level 2 (L2) cache 14, an I/O bridge 16, a memory controller 18, and an interconnect 20. The processors 12A-12B, the L2 cache 14, the I/O bridge 16, and the memory controller 18 are coupled to the interconnect 20. While the illustrated embodiment includes two processors 12A- 12B, other embodiments of the system 10 may include one processor or more than two processors. Similarly, other embodiments may include more than one L2 cache 14, more than one I/O bridge 16, and/or more than one memory controller 18. In one embodiment, the system 10 may be integrated onto a single integrated circuit chip (e.g. a system on a chip configuration). In other embodiments, the system 10 may comprise two or more integrated circuit components coupled together via a circuit board. Any level of integration may be implemented in various embodiments.

The processor 12A is shown in greater detail in FIG. 1. The processor 12B may be similar. In the illustrated embodiment, the processor 12A includes a processor core 22 (more briefly referred to herein as a “core”) and an interface unit 24. The interface unit 24 includes a memory request buffer 26. The interface unit 24 is coupled to receive a request address from the core 22 (Req. Addr in FIG. 1), and may also be coupled to provide a snoop address to the core 22 (not shown in FIG. 1) in some embodiments. Additionally, the interface unit 24 is coupled to receive data out and provide data in to the core 22 (Data Out and Data In in FIG. 1, respectively). Additional control signals (Ctl) may also be provided between the core 22 and the interface unit 24. The interface unit 24 is also coupled to communicate address, response, and data phases of transactions on the interconnect 20.

The core 22 generally includes the circuitry that implements instruction processing in the processor 12A, according to the instruction set architecture implemented by the processor 12A. That is, the core 22 may include the circuitry that fetches, decodes, executes, and writes results of the instructions in the instruction set. The core 22 may include one or more caches. In one embodiment, the processors 12A-12B implement the PowerPC™ instruction set architecture. However, other embodiments may implement any instruction set architecture (e.g. MIPS™, SPARC™, ×86 (also known as Intel Architecture-32, or IA-32), IA-64, ARM™, etc.). In the illustrated embodiment, the core 22 includes a load/store (L/S) unit 30 including a load/store queue (LSQ) 32.

The interface unit 24 includes the circuitry for interfacing between the core 22 and other components coupled to the interconnect 20, such as the processor 12B, the L2 cache 14, the I/O bridge 16, and the memory controller 18. In the illustrated embodiment, cache coherent communication is supported on the interconnect 20 via the address, response, and data phases of transactions on the interconnect 20. Generally, a transaction is initiated by transmitting the address of the transaction in an address phase, along with a command indicating which transaction is being initiated and various other control information. Cache coherent agents on the interconnect 20 use the response phase to maintain cache coherency. Each coherent agent responds with an indication of the state of the cache block addressed by the address, and may also retry transactions for which a coherent response cannot be determined. Retried transactions are cancelled, and may be reattempted later by the initiating agent. The order of successful (non-retried) address phases on the interconnect 20 may establish the order of transactions for coherency purposes. The data for a transaction is transmitted in the data phase. Some transactions may not include a data phase. For example, some transactions may be used solely to establish a change in the coherency state of a cached block. Generally, the coherency state for a cache block may define the permissible operations that the caching agent may perform on the cache block (e.g. reads, writes, etc.). Common coherency state schemes include the modified, exclusive, shared, invalid (MESI) scheme, the MOESI scheme which includes an owned state in addition to the MESI states, and variations on these schemes.

The interconnect 20 may have any structure. For example, the interconnect 20 may have separate address, response, and data interfaces to permit split transactions on the interconnect 20. The interconnect 20 may support separate address and data arbitration among the agents, permitting data phases of transactions to occur out of order with respect to the corresponding address phases. Other embodiments may have in-order data phases with respect to the corresponding address phase. In one implementation, the address phase may comprise an address packet that includes the address, command, and other control information. The address packet may be transmitted in one bus clock cycle, in one embodiment. In one particular implementation, the address interconnect may include a centralized arbiter/address switch to which each source agent (e.g. processors 12A-12B, L2 cache 14, and I/O bridge 16) may transmit address requests. The arbiter/address switch may arbitrate among the requests and drive the request from the arbitration winner onto the address interconnect. In one implementation, the data interconnect may comprise a limited crossbar in which data bus segments are selectively coupled to drive the data from data source to data sink.

The core 22 may generate various requests. Generally, a core request may comprise any communication request generated by the core 22 for transmission as a transaction on the interconnect 20. Core requests may be generated, e.g., for load/store instructions that miss in the data cache (to retrieve the missing cache block from memory), for fetch requests that miss in the instruction cache (to retrieve the missing cache block from memory), uncacheable load/store requests, writebacks of cache blocks that have been evicted from the data cache, etc. The interface unit 24 may receive the request address and other request information from the core 22, and corresponding request data for write requests (Data Out). For read requests, the interface unit 24 may supply the data (Data In) in response to receiving the data from the interconnect 20.

Generally, a buffer such as the memory request buffer 26 may comprise any memory structure that is logically viewed as a plurality of entries. In the case of the memory request buffer 26, each entry may store the information for one transaction to be performed on the interconnect 20. In some cases, the memory structure may comprise multiple memory arrays. For example, the memory request buffer 26 may include an address buffer configured to store addresses of requests and a separate data buffer configured to store data corresponding to the request, in some embodiments. An entry in the address buffer and an entry in the data buffer may logically comprise an entry in the memory request buffer 26, even though the address and data buffers may be physically read and written separately, at different times.

In one embodiment, the memory request buffer 26 may be used as a load merge buffer for uncacheable load requests. A first uncacheable load request may be written to the memory request buffer 26, having a first address to which the load request is directed. Additional uncacheable load requests, if they have an address matching the first address within a defined granularity, may be merged with the first uncacheable load request. For example, the granularity may be larger than the size of the uncacheable load requests (e.g. two merged uncacheable load requests may each access one or more bytes not accessed by the other request). Generally, merging uncacheable load requests may include performing the same, single transaction on the interconnect 20 to concurrently satisfy each of the merged requests. That, is, a single transaction is performed in the interconnect 20 and data returned from the single transaction is forwarded as the load result in the core 22 for each of the merged requests. If uncacheable load requests may not be merged, separate transactions may be used for each respective uncacheable load request. In one embodiment, merging the uncacheable load requests may be implemented by updating the entry in the memory request buffer 26 that stores the first uncacheable load request to ensure the data for the merged uncacheable load request is also read in the transaction. To the extent that uncacheable load requests are successfully merged, bandwidth consumed on the interconnect 20 by the processor 12A may be reduced, in some embodiments. Performance may be increased due to the freed bandwidth and/or power consumption may be reduced, in various embodiments.

A load memory operation (or more briefly, “a load”) may be generated by the core 22 responsive to an explicit load instruction, or responsive to an implicit load specified by any instruction. Loads may be cacheable (i.e. caching of the load data is permitted) or uncacheable (caching of the load data is not permitted). Loads may be specified as cacheable or uncacheable in any desired fashion, according to the instruction set architecture implemented by the processor 12A. For example, in some embodiments, cacheability (or uncacheability) is an attribute specified in the virtual to physical translation data structures used to translate the load address from virtual to physical. In some embodiments, instructions may encode cacheability/uncacheability directly. Combinations of such techniques may also be used.

Addresses may match within the defined granularity if the addresses both refer to data within a contiguous block of aligned memory of the size of the granularity. More particularly, least significant address bits that define offsets within the aligned memory may be ignored when comparing the addresses for a match. For example, if the granularity is 16 bytes, the least significant 4 bits of addresses may be ignored when comparing for address match.

In various embodiments, the granularity may be fixed or programmable. The granularity may be defined based on a variety of factors. For example, the granularity may be based on the capabilities of the devices that are targeted by uncacheable requests, in some embodiments. Alternatively, the granularity may be defined to be the width of a single data transfer (or “beat”) on the interconnect 20 (or a multiple of the width of a data transfer). The granularity may be defined to be the size of a cache block in the caches of the processor 12A, in other embodiments.

The uncacheable loads may be stored in the LSQ 32 in the load/store unit 30. Based on various implementation-dependent criteria, each load may be selected for processing. The load/store unit 30 may generate an uncacheable load request to the interface unit 24, which may merge the uncacheable load request with a previously recorded uncacheable load request or allocate a new buffer entry in the buffer 26 for the uncacheable load request.

In one implementation, the memory request buffer 26 may be a unified buffer comprising entries that may be used to store addresses of core requests and addresses of snoop requests, as well as corresponding data for the requests. In one embodiment, the memory request buffer 26 may be used as a store merge buffer. Cacheable stores (whether a cache hit or a cache miss) may be written to the memory request buffer 26. Additional cacheable stores to the same cache block may be merged into the memory request buffer entry. Subsequently, the modified cache block may be written to the data cache. Uncacheable stores may also be merged in the memory request buffer 26.

The L2 cache 14 may be an external level 2 cache, where the data and instruction caches in the core 22, if provided, are level 1 (L1) caches. In one implementation, the L2 cache 14 may be a victim cache for cache blocks evicted from the L1 caches. The L2 cache 14 may have any construction (e.g. direct mapped, set associative, etc.).

The I/O bridge 16 may be a bridge to various I/O devices or interfaces (not shown in FIG. 1). Generally, the I/O bridge 16 may be configured to receive transactions from the I/O devices or interfaces and to generate corresponding transactions on the interconnect 20. Similarly, the I/O bridge 16 may receive transactions on the interconnect 20 that are to be delivered to the I/O devices or interfaces, and may generate corresponding transactions to the I/O device/interface. In some embodiments, the I/O bridge 16 may also include direct memory access (DMA) functionality.

The memory controller 18 may be configured to manage a main memory system (not shown in FIG. 1). The memory in the main memory system may comprise any desired type of memory. For example, various types of dynamic random access memory (DRAM) such as synchronous DRAM (SDRAM), double data rate (DDR) SDRAM, etc. may form the main memory system. The processors 12A-12B may generally fetch instructions from the main memory system, and may operate on data stored in the main memory system. I/O devices may use the main memory system to communicate with the processors 12A-12B (e.g. via DMA operations or individual read/write transactions).

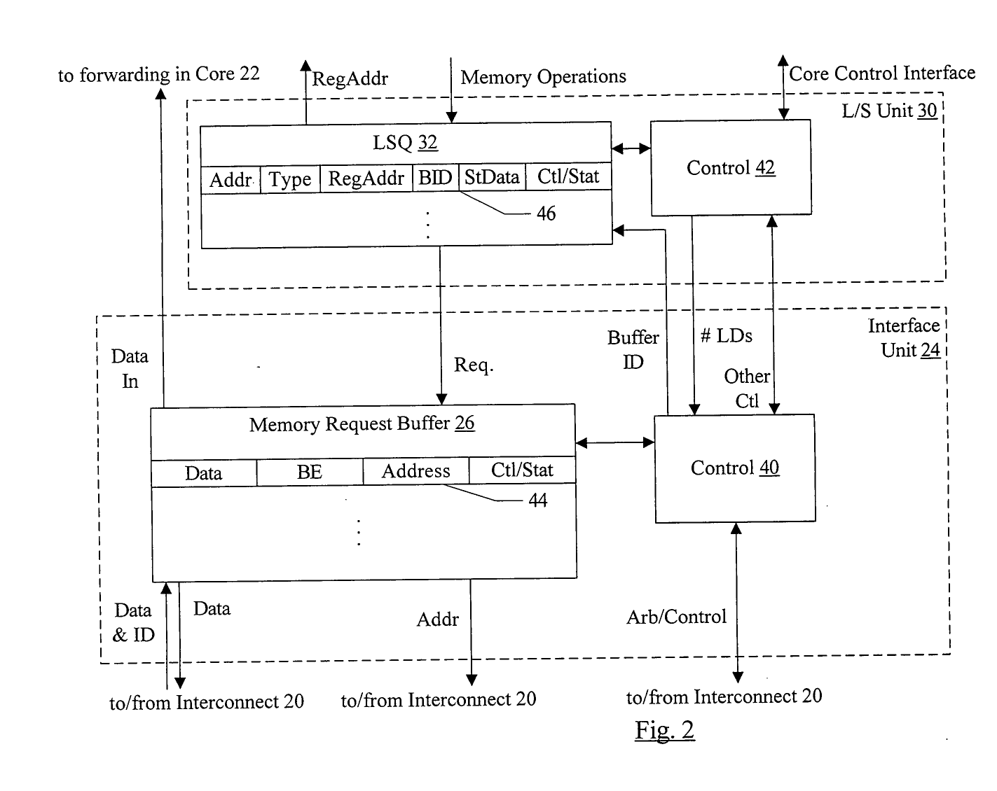

Turning now to FIG. 2, a block diagram of one embodiment of the load/store unit 30 and the interface unit 24 is shown. In the illustrated embodiment, the interface unit 24 includes the memory request buffer 26 and a control unit 40 coupled to the memory request buffer 26. The load/store unit 30 includes the LSQ 32 and a control unit 42 coupled to the LSQ 32. The control unit 40 is coupled to various control signals to/from the load/store unit 30, including a buffer identifier (ID) signal to provide the buffer ID to the LSQ 32 and a number of loads (# LDs) signal from the control unit 42. Additionally, the control unit 40 is coupled to various signals from the interconnect 20, including some of the arbitration and control signals (Arb/Control in FIG. 2). The memory request buffer 26 is coupled to the Data In to the core 22 (and a data out interface, not shown in FIG. 2) and is also coupled to receive/supply data for the data phases on the interconnect 20. The memory request buffer 26 is further coupled to receive a request from the LSQ 32 (Req. in FIG. 2) and may also be coupled to supply a snoop address to the core 22. The memory request buffer 26 may be coupled to receive the snoop address of snoop request from the interconnect 20 (not shown), and to supply an address to the interconnect 20. The control unit 42 is further coupled to a core control interface to receive/transmit control signals related to core-generated load/store memory operations. The LSQ 32 is coupled to receive core load/store memory operations, and to provide a register address (RegAddr) for forwarding load data to a register file. Certain signals illustrated in FIG. 2 highlight communication in the illustrated embodiment for uncacheable load processing. Additional communication may be implemented in various embodiments for uncacheable load processing, and other embodiments may implement different communication from that shown in FIG. 2. Furthermore, additional communication may be implemented for other types of requests, as desired.

In one embodiment, the control unit 40 may includes a set of queues (not shown in FIG. 2) to store pointers to entries in the memory request buffer 26. Each queue may correspond to a request type, and may store pointers to the memory request buffer entries that store requests of that type. The queues may track the order of requests of a given request type. A credit system may be used to control the use of memory request buffer entries for requests of different types.

An exemplary entry 44 is shown in the memory request buffer 26. Other entries may be similar. The entry 44 includes the address of the request and control/status information. The control/status information may include the command for the address phase, a transaction identifier (ID) that identifies the transaction on the interconnect 20, and various other status bits that may be updated as the transaction corresponding to a request is processed toward completion. The entry 44 may further include data (e.g. a cache block in size, in one embodiment) and a set of byte enables (BE). There may be a BE bit for each byte in the cache block. In one embodiment, a cache block may be 64 bytes and thus there may be 64 BE bits. Other embodiments may implement cache blocks larger or smaller than 64 bytes (e.g. 32 bytes, 16 bytes, 128 bytes, etc.) and a corresponding number of BE bits may be provided. The BE bits may be used for load merging, in some embodiments, and may also record which bytes are valid in the entry 44. For example, in one embodiment, a cache block of data may be transferred over multiple clock cycles on the interconnect 20. For example, 16 bytes of data may be transferred per clock cycle for a total of 4 clock cycles of data transfer on the interconnect 20 for a 64 byte block. Similarly, in some embodiments, multiple clock cycles of data transfer may occur on the Data Out/Data In interface to the core 22. For example, 16 bytes may be transferred per clock between the core 22 and the interface unit 24. The BE bits may record which bytes have been provided in each data transfer.

If the granularity for load merging is smaller than a cache block, only a portion of the BE bits may be used for a given uncacheable load request entry. The number of BE bits used may be based on the size of the granularity.

An exemplary entry 46 in the LSQ 32 is also shown in FIG. 2. Other LSQ entries may be similar. The entry 46 includes the address of the load/store memory operation and a type field storing a type of the load/store memory operation. The type field may identify the memory operation as a load or store, and may include other attributes such as cacheable/uncacheable, etc. The entry 46 also includes a register address field RegAddr identifying the target of a load. The register address may be drawn from the instruction corresponding to the load, or may be dynamically assigned in embodiments that implement register renaming. The entry 46 includes a buffer ID (BID) field to store the buffer ID provided from the interface unit 24, and a store data (StData) field for store data if the operation is a store. A control/status (Ctl/Stat) field may store various control and status data (e.g. a valid bit, the state of progress in processing the operation, cache hit/miss, etc.).

The load/store unit 30 receives core load/store memory operations from the rest of the core 22. The memory operations may include the address of the memory operation (that is, the address to be read for a load or written for a store), the type information including load or store and cacheable or uncacheable, the register address for loads, the size of the operation, etc. The core 22 may use the core control interface to indicate that a memory operation is being provided. The control unit 42 may allocate an entry in the LSQ 32 to store the memory operation.

The remainder of this discussion will focus on the uncacheable load memory operation, and illustrate the uncacheable load merging. Generally, an uncacheable load may be selected by the control unit 42 for transmission to the interface unit 42 according to any set of criteria. For example, the uncacheable load may be nonspeculatively selected (e.g. after each prior memory operation in the LSQ 32 has been retired or at least is nonspeculative), selected in order but speculatively (e.g. selected after each prior memory operation in the LSQ 32 but without regard to being nonspeculative), speculatively selected ahead of other loads, speculatively selected without restriction, etc.

When the uncacheable load has been selected, the control unit 42 may provide the entry number of the uncacheable load in the LSQ 32 to the LSQ 32 to read the information used to generate the uncacheable load request to the interface unit 24. The request may include the address, type, and size of the load, for example.

The memory request buffer 26 may be configured to compare the request address to the addresses in the buffer entries in response to receiving the request. For example, the memory request buffer 26 may comprise a content addressable memory (CAM), at least for the address portion of the entry. For uncacheable loads, the comparison may be made according to the defined granularity mentioned above, and the comparison result may be used to detect a potential load merge. If a CAM match is detected and a load merge is not possible, the control unit 40 may use a replay control signal (part of the Other Ctl in FIG. 2) to the control unit 42 to replay the request, in some cases. The assertion of the replay control signal may cause the control unit 42 to and reattempt the request again at a later time. The control unit 40 may also supply a buffer ID to the LSQ 32 indicating the buffer entry on which the match was detected. For a replay, the buffer ID may be matched to a buffer ID provided by the interface unit 24 when the request in that buffer entry completes, and may be used as a trigger to reattempt to replay the request. For uncacheable load requests that are merged, the buffer ID identifies the buffer entry in which the load request was merged.

If a request is not replayed or merged, the request is written to a buffer entry in the memory request buffer 26 allocated by the control unit 40. If the request is not replayed, the control unit 40 may transmit the buffer ID of the buffer entry to which the request is written to the LSQ 32. The LSQ 32 may write the buffer ID to the entry corresponding to the request. Subsequently, the request may be selected by the control unit 40 to initiate its transaction on the interconnect 20. For uncacheable load transactions, a subsequent data phase returns the data from the target of the transaction. In one embodiment, the data provided from the interconnect 20 may also include a transaction ID (ID in FIG. 2) that includes the index into the memory request buffer 26 of the corresponding request. That is, the transaction ID used by the interface unit 24 on the interconnect 20 may include within it the pointer to the buffer entry in the memory request buffer 26 that stores the request (along with a value identifying the processor 12A and any other desired transaction ID data). The transaction ID may be used as an index into the memory request buffer 26 to write data received from the interconnect 20. Alternatively, in other embodiments, the control unit 40 may determine which buffer entry corresponds to a given data phase and may cause the buffer 26 to write the data from the interconnect 20 into that buffer entry.

The data for the uncacheable load transaction may be forwarded from the memory request buffer 26 to the core 22 (e.g. to be written to a register file). The control unit 40 may also provide the buffer ID of the buffer entry from which data is being forwarded, and the LSQ 32 may compare the buffer ID to the buffer ID fields in its entries. The control unit 42 may select the oldest uncacheable load in the LSQ 32 which matches the buffer ID, and may read the RegAddr field of the entry to supply the register address for forwarding. The oldest uncacheable load may also be deleted from the LSQ 32 in response to the forwarding. The oldest uncacheable load may be the load that is prior, in program order, to other uncacheable loads to which it is being compared.

The control unit 42 may also provide an indication of the number of uncacheable loads that matched the buffer ID. The control unit 40 may repeat the forwarding a number of times equal to the number of loads, to forward data for each merged load.

It is noted that, while byte enables are used in the present embodiment to indicate which bytes are requested (e.g. for merged uncacheable loads), any indication of the data bytes being requested may be transmitted as part of the transaction for an uncacheable load request (or merged uncacheable load requests). For example, if merging were limited to requests that access a byte or bytes contiguous to bytes that were already requested, a byte count may be transmitted. In other embodiments, a given enable bit may correspond to more than one byte, if one byte granularity of data transfers is not supported on the interconnect 20.

The buffer 26 and LSQ 32 may comprise any type of memory. For example, the buffer 26 and LSQ 32 may comprise one or more random access memory (RAM) arrays, clocked storage devices such as flops, registers, latches, etc., or any combination thereof. In one embodiment, at least the portion of the buffer 26 that stores address bits and the portion of the LSQ 32 that stores the buffer ID may be implemented as a content addressable memory (CAM) for comparing addresses and buffer IDs as mentioned above.

It is noted that, while the LSQ 32 is shown in the illustrated embodiment, other embodiments may implement separate queues for loads and for stores.

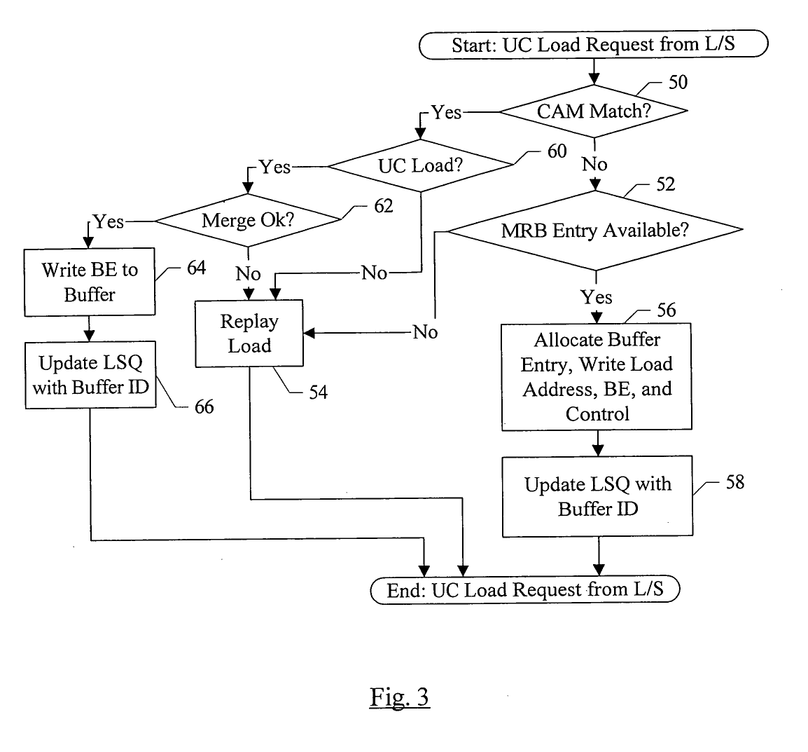

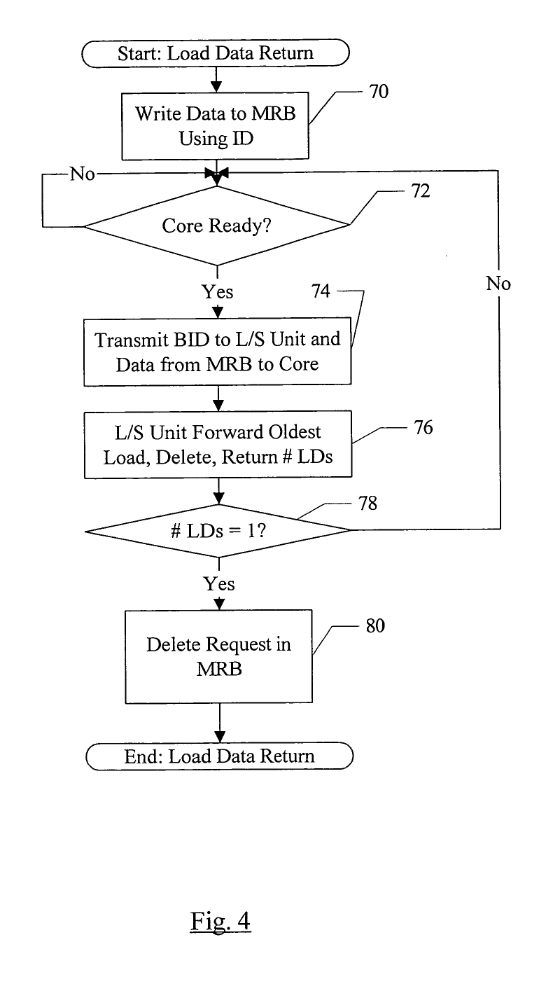

FIGS. 3-4 will next be described to illustrate additional details of uncacheable load requests and the operation of one embodiment of the interface unit 24 and load/store unit 30 for such requests. In each FIG. 3-4, the blocks are illustrated in a particular order for ease of understanding. However, other orders may be used. Furthermore, blocks may be performed in parallel in combinatorial logic in the interface unit 24 and/or load/store unit 30. Blocks, combinations of blocks, or a flowchart as a whole may be pipelined over multiple clock cycles in various embodiments.

FIG. 3 illustrates operation of one embodiment of the interface unit 24 and load/store unit 30 for an uncacheable load request that has been selected for issuance by the control unit 42 and has been transmitted as a request to the interface unit 24.

The load address is compared to the addresses in the memory request buffer 26. If no match is detected at the granularity used for uncacheable loads (decision block 50, “no” leg), the control unit 40 may check if a memory request buffer (MRB) entry is available to store the uncacheable load request. If no entry is available (decision block 52, “no” leg), the control unit 40 may assert replay for the load request (block 54). If an entry is available (decision block 52, “yes” leg), the control unit 40 may allocate a buffer entry, and may write the load request into the allocated buffer entry (block 56). The byte enables in the buffer entry may also be initialized by setting the BE bits for bytes requested by the load and clearing other BE bits. Other control information may also be written to the allocated buffer entry. The bytes requested by the load comprise the byte addressed by the load address and a number of contiguous bytes based on the size of the load request (e.g. 1, 2, 4, or 8 bytes in one embodiment). Additionally, the control unit 42 may provide the buffer ID of the allocated buffer entry to the LSQ 32, which may write by the buffer ID to the entry storing the load memory operation corresponding to the load request (block 58).

If there is a match of the load address in the buffer 26 within the granularity for load (decision block 50, “yes” leg), the control unit 40 may determine if the entry that is matched is also an uncacheable load request. If the request is not a load, or is a cacheable load, then a load merge is not permitted in this embodiment. If the entry that is matched is not an uncacheable load request (decision block 60, “no” leg), the control unit 40 may assert replay for the load request (block 54). If the match is on a buffer entry that is storing an uncacheable load request (decision block 60, “yes” leg), the control unit 40 may determine if the merge of the load request into the buffer entry is permitted (decision block 62). There may be a variety of reasons why a load request is not permitted to be merged into the buffer entry (referred to as a “merge buffer” for brevity). For example, the merge buffer may be “closed” because the transaction for the request has been initiated on the interconnect 20. Additional details regarding the closing of a merge buffer are provided below. Additionally, in some embodiments, a load request that reads a byte that is also read by a previously merged load request may not be permitted. For example, if an uncacheable load results in a change of state to the targeted location (e.g. a clear-on read register), such a merge may not be permitted. Other embodiments may permit merging a load request that reads a byte that is also read by a previously merged load request. If the merge is not permitted (decision block 62, “no” leg), the control unit 40 may assert replay for the load request (block 54). If the merge is permitted (decision block 62, “yes” leg), the buffer 26 may update the BE bits in the merge buffer (block 64). That is, the BE bits for bytes read by the load request may be set (if not already set). The control unit 40 may provide the buffer ID of the merge buffer to the LSQ 32 to be stored in the LSQ entry corresponding to the load request (block 66, similar to block 58).

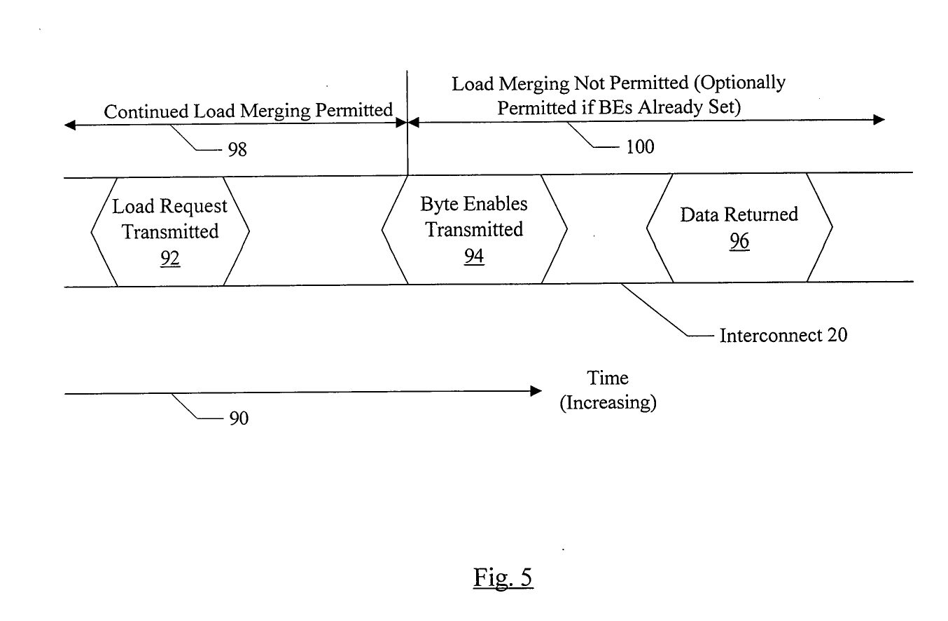

Merging of additional uncacheable load requests may be performed similar to FIG. 3 until the merge buffer is closed. As mentioned above, in some embodiments, the merge buffer may be closed when the transaction for the request in the merge buffer is initiated on the interconnect 20. The byte enables are transmitted as part of the transaction, and thus may not be changed after being transmitted in the transaction. In some embodiments, additional merging may be permitted if the load request to be merged accesses only bytes that were requested in the transaction (e.g. all BE bits that would be set to merge the load request are set in the BE bits that were transmitted in the transaction). In some embodiments, the transmission of the byte enables or other indication of the requested bytes may be delayed, and the merge buffer may not be closed until the byte enables have been transmitted. Additional details will be provided below with regard to FIG. 5. Other reasons for closing a merge buffer may also be implemented, in various embodiments. If a merge buffer is closed for some reason, the control unit 40 may initiate the transaction for the request in the merge buffer (arbitrating with other requests in the buffer 26 and arbitrating for the interconnect 20). For example, the number of memory request buffer entries that may be concurrently used for uncacheable load merging may be limited. If an uncacheable load request is received that is to allocate a new buffer entry and the limit has been reached, the new load request may be replayed and one of the existing merge buffers may be closed (e.g. the oldest one). A merge buffer may be closed if no new load requests have been merged within a timeout period. A merge buffer may be closed if no more uncacheable loads are in the LSQ 32. In such an embodiment, the core 22 may provide a control signal indicating that there are no additional loads in the LSQ 32. The merge buffer may be closed if a snoop request hits on the merge buffer. If any request is replayed due to a match on the merge buffer, the merge buffer may be closed. If the entire granularity is read via merged load requests, the merge buffer may be closed. Furthermore, a store request within the granularity of the merge may cause a merge buffer to be closed. One or more of the above reasons to close a merge buffer may be programmably enabled/disabled, in some embodiments.

FIG. 4 is a flowchart illustrating operation of one embodiment of the interface unit 24 and/or the load/store unit 30 for uncacheable load data returning from the interconnect 20.

The memory request buffer 26 may receive the transaction ID transmitted in the data phase on the interconnect 20 and may use the portion of the transaction ID that identifies the buffer entry as a write index to the buffer 26. The buffer 26 may write the data into the data field of the identified buffer entry (block 70). The control unit 40 may wait for the core to be ready for a forwarding of the data (decision block 72). For example, in one embodiment, a hole in the load/store pipeline that accesses the data cache may be required to forward data. When such a hole is provided, the forwarding may be scheduled. The control unit 40 may read the entry in the buffer 26, and the buffer 26 may transfer data from the buffer entry to the core 22 over the Data In interface (block 74). Additionally, the control unit 40 may also transmit the buffer ID to the LSQ 32. The LSQ 32 may compare the buffer ID to the stored buffer IDs, and the control unit 42 may cause the oldest load that matches the buffer ID to be forwarded. The register address from the oldest load may be output by the LSQ 32 to the forwarding hardware in the core 22. Additionally, in some embodiments, byte selection controls may be forwarded to identify which bytes from the buffer 26 are to be forwarded to the register destination (e.g. based on the address of the load being forwarded and the size of the load). The control unit 42 may delete the load request from the LSQ 32. Additionally, the load/store unit 32 may signal the number of loads that matched the buffer ID (including the one that was selected for forwarding) (block 76).

If the number of loads indicated by the control unit 42 is 1 (i.e. the oldest load is the only load), then the forwarding is complete and the control unit 40 may delete the request from the memory request buffer 26 (decision block 78, “yes” leg and block 80). On the other hand, if the number of loads indicated by the control unit is not 1 (decision block 78, “no” leg), the control unit 40 may attempt to schedule another forwarding of the data. The data may thus be forwarded a number of times equal to the number of loads that were merged into the entry. In some embodiments, the control unit 40 may determine the number loads after each forwarding attempt. In other embodiments, the number of loads may be determined at the first forwarding, and the control unit 42 may also record a list of the entry numbers in the LSQ 32 to be forwarded to. As the forwards are scheduled by the control unit 40, the control unit 42 may forward each entry according to the relative ages of the entries. Each forward may occur during a different clock cycle, or two or more forwards may be performed in parallel, in some embodiments, if forwarding hardware is provided to perform the forwards in parallel. Alternatively, the youngest entry in the LSQ 32 that matches the buffer ID may be marked, and when the control unit 40 may continue scheduling the forwarding of data until the marked entry is forwarded. Then, the forwarding for that merged load is complete and the buffer entry may be invalidated.

As mentioned previously, the transmission of the byte enables may be delayed from the initiation of the transaction for a set of merged load requests, to permit additional merging, in some embodiments. FIG. 5 is a timing diagram that illustrates one embodiment of the delayed transmission of byte enables. Time increases from left to right in FIG. 5, as illustrated by arrow 90, in arbitrary units.

At a first point in time, the transaction to read the bytes accessed by the merged loads is transmitted (block 92). The address of the transaction is transmitted, but the byte enables (or other indication of the requested bytes) is delayed until a later point in time (block 94). Byte enable transmission may be delayed in a variety of ways. For example, an additional command may be transmitted on the interconnect 20 to transmit the byte enables (block 94), after the command to initiate the transaction (block 92). Alternatively, the transaction may be defined to transmit the byte enables at a later time (e.g. in response to a signal from the target of the request, or at a predetermined delay from the initiation of the transaction). Sideband signals may also be used to transmit the byte enables, rather than transmitting them on the interconnect 20. Subsequent to transmitting the byte enables, the data is returned (block 96).

Additional load merging may be permitted up until the byte enables are transmitted, even though the transaction to read the bytes has been initiated (arrow 98). Subsequent to transmission of the byte enables, load merging may not be permitted (arrow 100). Optionally, load merging may be permitted if the byte enables that would be set be a load are already set in the byte enables that were transmitted for the transaction.

Numerous variations and modifications will become apparent to those skilled in the art once the above disclosure is fully appreciated. It is intended that the following claims be interpreted to embrace all such variations and modifications.

What is claimed is:

1. A processor comprising:
a buffer configured to store requests to be transmitted on an interconnect on which the processor is configured to communicate, wherein the buffer is coupled to receive a first uncacheable load request having a first address; and
a control unit coupled to the buffer, wherein the control unit is configured to merge the first uncacheable load request with a second uncacheable load request that is stored in the buffer responsive to a second address of the second load request matching the first address within a granularity, wherein a single transaction on the interconnect is used for both the first and second uncacheable load requests, if merged, and wherein separate transactions on the interconnect are used for each of the first and second uncacheable load requests if not merged.

2. The processor as recited in claim 1 wherein the buffer is coupled to receive one or more additional uncacheable load requests, and wherein the control unit is configured to merge the additional uncacheable load requests with the second uncacheable load request if addresses of the additional uncacheable load requests match the second address within the granularity.

3. The processor as recited in claim 1 wherein the control unit is configured to initiate the single transaction on the interconnect for the second uncacheable load request and any merged uncacheable load requests, and wherein the single transaction includes an indication of the data bytes to be supplied in response to the single transaction.

4. The processor as recited in claim 3 wherein the indication comprises byte enables.

5. The processor as recited in claim 3 wherein the control unit is configured not to merge a third uncacheable load request received subsequent to initiating the transaction even if a third address of the third uncacheable load request matches the second address within the granularity.

6. The processor as recited in claim 3 wherein the control unit is configured to merge a third uncacheable load request received subsequent to initiating the transaction if a third address of the third uncacheable load request matches the second address within the granularity and the third uncacheable load request accesses bytes that were requested in the transaction.

7. The processor as recited in claim 3 wherein the control unit is configured to delay transmission of the indication of the data bytes from the initiation of the transaction, and wherein the control unit is configured to merge a third uncacheable load request received after the initiation but before the transmission of the indication of the data bytes responsive to a third address of the third uncacheable load request matching the second address within the granularity.

8. The processor as recited in claim 7 wherein the control unit is configured to transmit the indication of the data bytes as a separate command on the interconnect from the initiation of the transaction.

9. The processor as recited in claim 7 wherein the control unit is configured to transmit the indication of the data bytes as a sideband communication on the interconnect.

10. The processor as recited in claim 1 wherein the granularity is a width of a data transfer on the interconnect.

11. The processor as recited in claim 1 wherein the granularity is a cache block.

12. The processor as recited in claim 1 wherein the granularity is dependent on capabilities of a device targeted by the transaction.

13. The processor as recited in claim 1 further comprising a queue configured to store a first buffer identifier corresponding to the first uncacheable load request and identifying a buffer entry in the buffer allocated to the first uncacheable load request, and wherein the queue is further configured to store a second buffer identifier corresponding to the second uncacheable load request and identifying a buffer entry in the buffer allocated to the second uncacheable load request, wherein the first buffer identifier is equal to the second buffer identifier if the first uncacheable load request is merged with the second uncacheable load request.

14. The processor as recited in claim 13 wherein data returned on the interconnect in response to the single transaction is stored in the buffer, and wherein the control unit is configured to transmit the buffer identifier of the buffer entry storing the data to the queue, and wherein the buffer identifier matches both the first buffer identifier and the second buffer identifier.

15. The processor as recited in claim 14 wherein the control unit is configured to forward data from the buffer entry a number of times equal to the number of matches of the buffer identifier in the queue.

16. The processor as recited in claim 15 wherein the queue is configured to store a register address of a target register for each uncacheable load request, and wherein the queue is configured to supply the register address from the oldest entry that matches the buffer identifier for each data forwarding.

17. A method comprising:
receiving a first uncacheable load request having a first address;
merging the first uncacheable load request with a second uncacheable load request that is stored in a buffer awaiting transmission on an interconnect, the merging responsive to a second address of the second load request matching the first address within a granularity; and
performing a single transaction on the interconnect for both the first and second uncacheable load requests, if merged.

18. The method as recited in claim 17 further comprising:
storing data received in response to the single transaction in the buffer; and
forwarding data from the buffer a number of times equal to the number of uncacheable load requests merged with the second uncacheable load request.

19. The method as recited in claim 17 wherein the performing comprises delaying a transmission of an indication of the data bytes to be transferred for the single transaction, the method further comprising merging a third uncacheable load request received after initiation of the single transaction but before the transmission of the indication of the data bytes, the merging responsive to a third address of the third uncacheable load request matching the second address within the granularity.
